(19) United States
(12) Patent Application Publication
(10) Pub. No.: US 2022/0073797 A1
(43) Pub. Date: Mar. 10, 2022

(54) Two-Component Solvent-Based Adhesive Composition

(71) Applicants: Dow Global Technologies LLC, Midland, MI (US); Rohm and Haas Company, Collegeville, PA (US)

(72) Inventors: Rui Shi, Shanghai (CN); Zhaohui Qu, Shanghai (CN); Gaobing Chen, Shanghai (CN)

(21) Appl. No.: 17/414,464

(22) PCT Filed: Dec. 21, 2018
(86) PCT No.: PCT/CN2018/122619

§ 371 Date: Jun. 16, 2021

(51) Int. Cl. C09J 175/06; C08G 18/42; C08G 18/34; C08G 18/32; C08G 18/65; C08G 18/72; C08G 18/22; C09J 7/30; C09J 7/24; C09J 7/28; B32B 7/12; B32B 15/085

(52) U.S. Cl. CPC C09J 175/06; B32B 2439/70; C08G 18/341; C08G 18/3206; C08G 18/6541; C08G 18/6511; C08G 18/72; C08G 18/222; C09J 7/30; C09J 7/243; C09J 7/28; B32B 7/12; B32B 15/085; C09J 2475/00; C09J 2423/046; C09J 2400/163; B32B 2250/02; C08G 18/4288

(57) ABSTRACT

The present disclosure provides a two-component adhesive composition. The two-component solvent-based adhesive composition contains the reaction product of (A) an isocyanate component; (B) a dimer acid polyester polyol component containing the reaction product of a reaction mixture including (i) from 20 wt % to 60 wt % dimer acid, based on the total weight of the dimer acid polyester polyol component, (ii) a dicarboxylic acid, and (iii) a polyol; and (C) a solvent.

### BACKGROUND

Laminates are traditionally formed with solvent-based adhesives that exhibit poor adhesion after chemical aging and/or after high temperature testing such as a boil-in-bag test. These laminates are unsuitable for a number of laminate applications, such as food packaging, which require sufficient adhesion for a period of time after exposure to heat and/or chemicals. Insufficient adhesion results in defects in the laminate structure, such as bubbling and delamination.

The art recognizes the need for a solvent-based adhesive that exhibits sufficient adhesion between substrates after exposure to heat and/or chemicals.

### SUMMARY

The present disclosure provides a two-component solvent-based adhesive composition. The two-component solvent-based adhesive composition contains the reaction product of (A) an isocyanate component; (B) a dimer acid polyester polyol component containing the reaction product of a reaction mixture including (i) from 20 wt % to 60 wt % dimer acid, based on the total weight of the dimer acid polyester polyol component, (ii) a dicarboxylic acid, and (iii) a polyol; and (C) a solvent.

The present disclosure also provides a method of forming a two-component solvent-based adhesive composition. The method includes (i) providing a dimer acid polyester polyol component containing from 20 wt % to 60 wt % units derived from dimer acid, based on the total weight of the dimer acid polyester polyol component, (ii) providing an isocyanate component; and (iii) reacting the dimer acid polyester polyol component with the isocyanate component to form the two-component solvent-based adhesive composition.

### Definitions

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

The term “composition” refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

A “dicarboxylic acid” is a compound containing two carboxyl (—COOH) groups.

An “isocyanate” is a chemical that contains at least one isocyanate group in its structure. An isocyanate group is represented by the formula: —N═C═O. An isocyanate that contains more than one, or at least two, isocyanate groups is a “polyisocyanate” or a “multifunctional isocyanate.” An isocyanate that has two isocyanate groups is a di-isocyanate and an isocyanate that has three isocyanate groups is a tri-isocyanate, etc. An isocyanate may be aromatic or aliphatic.

A “polyester” is a compound containing two or more ester linkages in the same linear chain of atoms.

A “polyester polyol” is a compound that is a polyester and a polyol. Nonlimiting examples of suitable polyester polyols include polycondensates of diols, polyols (e.g., triols, tetraols), dicarboxylic acids, polycarboxylic acids (e.g., tricarboxylic acids, tetracarboxylic acids), hydroxycarboxylic acids, lactones, and combinations thereof. The polyester polyols can also be derived from, instead of the free polycarboxylic acids, the corresponding polycarboxylic anhydrides, or corresponding polycarboxylic esters of lower alcohols.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, etc. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

A “polyol” is an organic compound containing multiple hydroxyl (—OH) groups. In other words, a polyol contains at least two hydroxyl groups. Nonlimiting examples suitable polyols include diols (which contain two hydroxyl groups) and triols (which contain three hydroxyl groups).

### Test Methods

Acid value (or acid number) is measured in accordance with ASTM D 1386/7. Acid value is a measure of the amount of carboxylic acid present in a component or a composition. The acid value is the number of milligrams of potassium hydroxide required for the neutralization of free carboxylic acids present in one gram of a substance (e.g., the ethylene-based polymer or dispersant). Units for acid value are mg KOH/g.

Dimer acid content of the dimer acid polyester polyol is measured in accordance with ASTM D6866, based on renewable content.

Hydroxyl number (or hydroxyl value) is a measure of the number of hydroxyl groups present in a component or a composition. The hydroxyl number is the number of milligrams of potassium hydroxide required to neutralize the hydroxyl groups in one gram of a substance (mg KOH/g). The hydroxyl number is determined in accordance with DIN 53240.

Isocyanate group (NCO) content by weight is measured in accordance with ASTM D2572-97.

Weight average molecular weight (Mw) is measured using a gel permeation chromatography (GPC) system.

Bond Strength (90° T-Peel Test)

Bond strength is measured in accordance with the 90° hand-assisted T-Peel Test. The laminate is cut into “175 mm×15 mm” strips (each strip had a bond area of “175 mm×15 mm”) after curing in an oven at 50° C. and for two days for the initial T-peel bond strength test. An Instron 5943 peel tester is set at a 250 mm/min crosshead speed. During testing, the tail of the strip is pulled slightly by finger to make sure the tail remains oriented at 90° to the peeling direction. The average bond strength (Newtons per 15 millimeter (N/15 mm)) is determined from the force versus distance profile. Three samples are tested and the average “bond strength” reported.

Bond strength is also measured after chemical aging and the boil-in-bag test.

Heat Seal Strength

Laminates are heat sealed in a HSG-C Heat-Sealing Machine, available from Brugger Company, under 140° C. seal temperature and 300N pressure for 1 second, are then cooled to room temperature (23° C.) and cut into “175 mm×15 mm” strips (each strip had a heat seal area of “175 mm×15 mm”).

A 5940 Series Single Column Table Top System, available from Instron Corporation, set at a crosshead speed of 250 mm/min, is used to measure the heat seal strength of the strip. Three samples are tested and the average “heat seal strength” is reported in Newtons per 15 millimeter (N/15 mm).

Boil-In-Bag

Laminates of 8 inches (20.32 cm)×12 inches (30.48 cm) are folded onto themselves to provide a structure that is 20.32 cm×15.24 cm, the structure having a first side and a second side. Thus, the first side and the second side each is formed from the same laminate. The first substrate (PE film) of the first side is in contact with the first substrate (PE film) of the second side. The structure has four edges, including a fold edge and three open edges. Two of the open edges are heat sealed to form a pouch. Heat sealing occurs at 140° C. for 1 second at a pressure of 300 N/15 mm. Two to three pouches are made from each example.

Each pouch is filled through the remaining open edge with 180 mL of a soup (Morton soup, which is a mixture of bean oil, ketchup, and vinegar with a 1:1:1 mixing ratio). Splashing the soup onto a heat seal area is avoided to prevent heat seal failure. After filling, the open edge is heat sealed in a manner that minimizes air entrapment inside of the closed pouch. Each closed pouch has four closed edges and an interior void that is 18.82 cm×13.74 cm (which is filled with soup). The integrity of each heat seal is visually inspected to ensure there are no flaws in the sealing that would cause the pouch to leak during testing. Pouches with suspected flaws are discarded and replaced.

A pot is filled ⅔ full with water, and brought to a rolling boil. The boiling pot is covered with a lid to minimize water and steam loss. The pot is observed during the test to ensure enough water is present to maintain boiling. The pouches are individually placed in the boiling water, and kept in the boiling water for 30 minutes. The pouches are then removed from the boiling water and visually inspected for tunneling, bubbling, blistering, delamination, and/or leakage.

The pouches are cut open, emptied of soup, and rinsed with soap and water. One or more strips (15 mm×175 mm) of laminate are cut from the pouches (excluding heat seal areas). Bond strength of the laminate is measured in accordance with the 90° T-Peel Test as described above. Heat seal strength of the laminate is measured in accordance with the heat seal strength test described above. Bond strength and heat seal strength are measured as soon as possible after the pouches are emptied of soup. The interior of the pouches are visually inspected for defects.

Chemical Aging

Laminates of 8 inches (20.32 cm)×12 inches (30.48 cm) are folded onto themselves to provide a structure that is 20.32 cm×15.24 cm, the structure having a first side and a second side. Thus, the first side and the second side each is formed from the same laminate. The first substrate (PE film) of the first side is in contact with the first substrate (PE film) of the second side. The structure has four edges, including a fold edge and three open edges. Two of the open edges are heat sealed to form a pouch. Heat sealing occurs at 140° C. for 1 second at a pressure of 300 N/15 mm. Two to three pouches are made from each example.

Each pouch is filled through the remaining open edge with 180 mL of a fabric softener (Comfort™ Softener, available from Unilever™). Splashing the fabric softener onto a heat seal area is avoided to prevent heat seal failure. After filling, the open edge is heat sealed in a manner that minimizes air entrapment inside of the closed pouch. Each closed pouch has four closed edges and an interior void that is 18.82 cm×13.74 cm (which is filled with fabric softener). The integrity of each heat seal is visually inspected to ensure there are no flaws in the sealing that would cause the pouch to leak during testing. Pouches with suspected flaws are discarded and replaced.

The pouches filled with fabric softener are placed in an oven at a temperature of 60° C. for a period of 1 week. The pouches are then removed from the oven, cooled to room temperature, and visually inspected for tunneling, bubbling, blistering, delamination, and/or leakage.

The pouches are cut open, emptied of fabric softener, and rinsed with water. One or more strips (15 mm×175 mm) of laminate are cut from the pouches (excluding heat seal areas). Bond strength of the laminate is measured in accordance with the 90° T-Peel Test as described above. Heat seal strength of the laminate is measured in accordance with the heat seal strength test described above. Bond strength and heat seal strength are measured as soon as possible after the pouches are emptied of fabric softener. The interior of the pouches are visually inspected for defects.

### DETAILED DESCRIPTION

The present disclosure provides a two-component solvent-based adhesive composition. The two-component solvent-based adhesive composition contains the reaction product of (A) an isocyanate component; (B) a dimer acid polyester polyol component containing the reaction product of a reaction mixture including (i) from 20 wt % to 60 wt % dimer acid, based on the total weight of the dimer acid polyester polyol component, (ii) a dicarboxylic acid, and (iii) a polyol; and (C) a solvent.

A. Isocyanate Component

The two-component solvent-based adhesive composition contains the reaction product of (A) an isocyanate component; (B) a dimer acid polyester polyol component; and (C) a solvent.

Nonlimiting examples of suitable isocyanate components include aromatic isocyanates, aliphatic isocyanates, carbodiimide modified isocyanates, polyisocyanate adducts, polyisocyanate trimers, and the combinations thereof.

An “aromatic isocyanate” is an isocyanate containing one or more aromatic rings. Nonlimiting examples of suitable aromatic isocyanates include isomers of methylene diphenyl dipolyisocyanate (MDI) such as 4,4′-MDI, 2,4′-MDI, and 2, 2′-MDI; modified MDI such as carbodiimide modified MDI or allophanate modified MDI; isomers of toluene-dipolyisocyanate (TDI) such as 2,4-TDI, and 2,6-TDI; isomers of naphthalene-dipolyisocyanate (NDI) such as 1, 5-NDI; isomers of phenylene dipolyisocyanate (PDI), such as 1,3-PDI and 1,4-PDI; and combinations thereof.

An “aliphatic isocyanate” is an isocyanate in which the isocyanate group (—NCO) is not directly bonded to an aromatic ring. In an embodiment, the aliphatic isocyanate is void of, or contains no, aromatic rings. Aliphatic isocyanates include cycloaliphatic isocyanate, in which the chemical chain is ring-structured. In an embodiment, the aliphatic isocyanate contains from 3, or 4, or 5, or 6 to 7, or 8, 10, 12, or 13, or 14, or 15, or 16 carbon atoms in the linear, branched, or cyclic alkylene residue. Nonlimiting examples of suitable aliphatic isocyanates include cyclohexane diisocyanate; methylcyclohexane diisocyanate; ethylcyclohexane diisocyanate; propylcyclohexane diisocyanate; methyldiethylcyclohexane diisocyanate; propane diisocyanate; butane diisocyanate; pentane diisocyanate; hexane diisocyanate; heptane diisocyanate; octane diisocyanate; nonane diisocyanate; nonane triisocyanate, such as 4-isocyanatomethyl-1,8-octane diisocyanate (TIN); decane di- and tri-isocyanate; undecane di- and tri-isocyanate; dodecane di- and tri-isocyanate; isophorone diisocyanate (IPDI); hexamethylene diisocyanate (HDI); diisocyanatodicyclohexylmethane (H12MDI); 2-methylpentane diisocyanate (MPDI); 2,2,4-trimethylhexamethylene diisocyanate; 2,4,4-trimethylhexamethylene diisocyanate; norbornane diisocyanate (NBDI); xylylene diisocyanate (XDI); tetramethylxylylene diisocyanate; isomers, dimers, and/or trimers thereof; and combinations thereof.

Nonlimiting examples of additional suitable isocyanates include 4-methyl-cyclohexane 1,3-diisocyanate; 2-butyl-2-ethylpentamethylene diisocyanate; 3(4)-isocyanatomethyl-1-methylcyclohexyl isocyanate; 2-isocyanatopropylcyclohexyl isocyanate; 2,4′-methylenebis (cyclohexyl) diisocyanate; 1,4-diisocyanato-4-methyl-pentane; and combinations thereof.

In an embodiment, the isocyanate is an oligomeric isocyanate that is the oligomeric reaction product of an isocyanate and a polyol.

A “polyisocyanate adduct” is the reaction product of an excess quantity of di-isocyanate with low molecular weight glycols and polyols having a molecular weight less than 400 g/mol (such trimethylolpropane, glycerin, 1,2-dihydroxy propane, and combinations thereof). A nonlimiting example of a suitable polyisocyanate adduct is the oligomeric reaction product of toluene di-isocyanate (TDI), 2,2′-oxydiethanol, and propylidenetrimethanol (said oligomeric isocyanate being available under CAS 53317-61-6).

A “polyisocyanate timer” is the reaction product prepared by trimerization of di-isocyanates in the presence of a catalyst. A nonlimiting example of a polyisocyanate trimer is 2,4-TDI trimer (said polyisocyanate trimer being available under CAS 26603-40-7).

In an embodiment, the isocyanate is a multifunctional isocyanate. In another embodiment, the multifunctional isocyanate is selected from a di-isocyanate, a tri-isocyanate, and combinations thereof. In a further embodiment, the multifunctional isocyanate is a di-isocyanate.

In an embodiment, the isocyanate is a multifunctional isocyanate with at least two isocyanate groups, or at least three isocyanate groups.

In an embodiment, the isocyanate is a multifunctional isocyanate having an average isocyanate (NCO) functionality from 2.2 to 5.0.

The isocyanate component may comprise two or more embodiments disclosed herein.

B. Dimer Acid Polyester Polyol Component

The two-component solvent-based adhesive composition contains the reaction product of (A) the isocyanate component; (B) a dimer acid polyester polyol component; and (C) a solvent. The dimer acid polyester polyol component (herein referred to as the “DAPP Component”) contains the reaction product of a reaction mixture including (i) from 20 wt % to 60 wt % dimer acid, based on the total weight of the DAPP Component, (ii) a dicarboxylic acid, and (iii) a polyol. Dimer Acid

The DAPP Component contains the reaction product of a reaction mixture including (i) from 20 wt % to 60 wt % dimer acid, based on the total weight of the DAPP Component, (ii) a dicarboxylic acid, and (iii) a polyol.

A “dimer acid” is a dicarboxylic acid compound obtained by allowing a fatty acid having from two to four ethylenic double bonds and from 14 to 22 carbon atoms (hereinafter referred to as “Unsaturated Fatty Acid A”), and a fatty acid having from one to four ethylenic double bonds and from 14 to 22 carbon atoms (hereinafter referred to as an “Unsaturated Fatty Acid B”), to react on double bonds in a dimerization reaction. In an embodiment, Unsaturated Fatty Acid A has two ethylenic double bonds and from 14 to 22 carbon atoms, and the Unsaturated Fatty Acid B has one or two ethylenic double bonds and from 14 to 22 carbon atoms. Nonlimiting examples of suitable Unsaturated Fatty Acid A include tetradecadienoic acids, hexadecadienoic acids, octadecadienoic acids (such as linoleic acid), eicosadienoic acids, docosadienoic acids, octadecatrienoic acids (such as linolenic acid), eicosatetraenoic acids (such as arachidonic acid), and combinations thereof. Nonlimiting examples of suitable Unsaturated Fatty Acid B include the above examples, as well as tetradecenoic acids (tsuzuic acid, physeteric acid, myristoleic acid), hexadecenoic acids (such as pa lmitoleic acid), octadecenoic acids (such as oleic acid, elaidic acid, and vaccenic acid), eicosenoic acids (such as gadoleic acid), and docosenoic acids (such as erucic acid, setoleic acid, and brassidic acid), and combinations thereof.

The obtained dimer acid is a mixture of dimer acids the structures of which differ according to the binding site or isomerization of a double bond. A nonlimiting example of a suitable dimer acid structure is the following Structure (A):

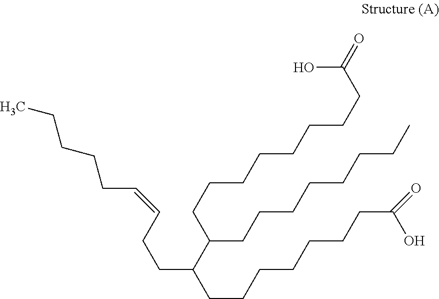 [SMILES: CCCCC/C=C\CCC(CCCCCCCC(=O)O)C(CCCCCCCC)CCCCCCCCC(=O)O]

In an embodiment, the dimer acid is a C₃₆ dimer acid. In a further embodiment, the C₃₆ dimer acid has the Structure (A).

In an embodiment, the obtained dimer acid includes from 0 wt % to 2 wt %, or 4 wt %, or 6 wt % monomer acid and/or from 0 wt % to 2 wt %, or 4 wt %, or 6 wt % polymer acid having a degree of polymerization greater than, or equal to, the degree of polymerization of a trimer acid.

In an embodiment, the dimer acid is unsaturated. An “unsaturated dimer acid” includes at least one carbon-carbon double bond. Structure (A) is an unsaturated dimer acid. A nonlimiting example of a suitable dimer acid is ATUREX™ 1001 (CAS 61788-89-4), available from Aturex Group.

In an embodiment, the dimer acid has an acid value from 150 mg KOH/g, or 160 mg KOH/g, or 170 mg KOH/g, or 180 mg KOH/g, or 190 mg KOH/g, or 194 mg KOH/g to 200 mg KOH/g, or 210 mg KOH/g, or 220 mg KOH/g, or 230 mg KOH/g, or 240 mg KOH/g, or 250 mg KOH/g. In another embodiment, the dimer acid has an acid value from 150 mg KOH/g to 250 mg KOH/g, or from 180 mg KOH/g to 220 mg KOH/g, or from 190 mg KOH/g to 200 mg KOH/g.

In an embodiment, the dimer acid has the Structure (A) and has an acid value from 150 mg KOH/g to 250 mg KOH/g, or from 180 mg KOH/g to 220 mg KOH/g, or from 190 mg KOH/g to 200 mg KOH/g. In a further embodiment, the dimer acid is ATUREX™ 1001 (CAS 61788-89-4), available from Aturex Group.

The dimer acid may comprise two or more embodiments disclosed herein.

Dicarboxylic Acid

The DAPP Component contains the reaction product of a reaction mixture including (i) the dimer acid, (ii) a dicarboxylic acid, and (iii) a polyol.

The (ii) dicarboxylic acid is not a dimer acid. In other words, the (ii) dicarboxylic acid is structurally distinct and/or compositionally distinct from the (i) dimer acid in the reaction mixture.

Nonlimiting examples of suitable dicarboxylic acids include aliphatic acids, aromatic acids, and combinations thereof. Nonlimiting examples of suitable aromatic dicarboxylic acids include phthalic acid, isophthalic acid, and terephthalic acid. Nonlimiting examples of suitable of suitable aliphatic dicarboxylic acids include hexahydrophthalic acid, cyclohexane dicarboxylic acid, adipic acid, azelaic acid, sebacic acid, glutaric acid, maleic acid, fumaric acid, itaconic acid, malonic acid, suberic acid, 2-methyl succinic acid, 3, 3-diethyl glutaric acid, 2, 2-dimethyl succinic acid, and trimellitic acid. As used herein, the term “acid” also includes any anhydrides of said acid. Saturated aliphatic and/or aromatic acids are also suitable, such as adipic acid or isophthalic acid.

In an embodiment, the dicarboxylic acid has from four, or five, or six to seven, or eight, or nine, or ten carbon atoms. In another embodiment, the dicarboxylic acid has from four to ten carbon atoms, or from six to eight carbon atoms. In a further embodiment, the dicarboxylic acid has eight carbon atoms.

In an embodiment, the dicarboxylic acid is selected from phthalic acid, isophthalic acid, terephthalic acid, azelaic acid, sebacic acid, adipic acid, and combinations thereof. In a further embodiment, the dicarboxylic acid is selected from phthalic acid, isophthalic acid, terephthalic acid, and combinations thereof. In another embodiment, the dicarboxylic acid is phthalic acid.

The dicarboxylic acid may comprise two or more embodiments disclosed herein.

Polyol

The DAPP Component contains the reaction product of a reaction mixture including (i) the dimer acid, (ii) the dicarboxylic acid, and (iii) a polyol.

Nonlimiting examples suitable polyols include diols (which contain two hydroxyl groups), triols (which contain three hydroxyl groups), and combinations thereof. In an embodiment, the polyol includes a diol and a triol.

Nonlimiting examples of suitable diols include 2-methyl-1, 3-propanediol (MPG); 3-methyl-1,5-pentanediol (MPD); ethylene glycol; butylene glycol; diethylene glycol (DEG); triethylene glycol; polyalkylene glycols, such as polyethylene glycol; 1, 2-propanediol; 1, 3-propanediol; 1, 3-butanediol; 1, 4-butanediol; 1, 6-hexanediol; and neopentyl glycol (NPG).

A nonlimiting example of a suitable triol is trimethylolpropane (TMP).

In an embodiment, the polyol is selected from 2-methyl-1, 3-propanediol (MPG), trimethylolpropane (TMP), 1, 4-butanediol, 1, 6-hexanediol, and neopentyl glycol (NPG), and combinations thereof.

In an embodiment, the polyol includes from 96.0 wt %, or 98.0 wt %, or 98.4 wt % to 98.7 wt %, or 99.0 wt % diol; and a reciprocal amount of triol; or from 1.0 wt %, or 1.3 wt % to 1.6 wt %, or 2.0 wt %, or 4.0 wt % triol, based on the total weight of polyol in the reaction mixture.

In an embodiment, the polyol includes from 98.0 wt %, or 98.4 wt % to 98.7 wt %, or 99.0 wt % MPG; and a reciprocal amount of TMP; or from 1.0 wt %, or 1.3 wt % to 1.6 wt %, or 2.0 wt % TMP, based on the total weight of polyol in the reaction mixture.

In an embodiment, the polyol includes a triol and a diol at a triol:diol weight ratio from 0.010:1, or 0.013:1 to 0.016:1, or 0.020:1, or 0.040:1. In another embodiment, the polyol includes a triol and a diol at a triol:diol weight ratio from 0.010:1 to 0.040:1, or from 0.010:1 to 0.020:1, or from 0.013:1 to 0.016:1.

In an embodiment, the polyol excludes polyalkylene glycols, such as polyethylene glycol (also known as polyether glycol).

The polyol may comprise two or more embodiments disclosed herein.

Optional Reaction Mixture Additive

In an embodiment, the DAPP Component contains the reaction product of a reaction mixture including (i) from 20 wt % to 60 wt % dimer acid, (ii) the dicarboxylic acid, (iii) the polyol, and (iv) an optional additive.

Nonlimiting examples of suitable optional additives include adhesion promoters, chain extenders, catalysts, and combinations thereof.

Nonlimiting examples of a suitable adhesion promoters include aminosilane, epoxy silane, phosphate ester, epoxy resin, and combination thereof.

Nonlimiting examples of suitable chain extenders include glycerine; trimethylol propane; diethylene glycol; propanediol; 2-methyl-1, 3-propanediol; 3-methyl-1, 5-pentanediol; and combinations thereof.

Nonlimiting examples of suitable catalysts include tetra-n-butyl titanate, zinc sulphate, organic tin catalyst, and combinations thereof.

In an embodiment, the reaction mixture excludes a chain extender.

The optional additive may comprise two or more embodiments disclosed herein.

Reaction Mixture

The DAPP Component contains the reaction product of a reaction mixture including (i) from 20 wt % to 60 wt % dimer acid, based on the total weight of the DAPP Component, (ii) the dicarboxylic acid, (iii) the polyol, and (iv) optionally, an additive.

In an embodiment, the reaction mixture includes from 20 wt %, or 25 wt %, or 30 wt %, or 35 wt %, or 40 wt %, or 41 wt % to 52 wt %, or 55 wt %, or 60 wt % dimer acid, based on the total weight of the reaction mixture. In another embodiment, the reaction mixture includes from 20 wt % to 60 wt %, or from 20 wt % to 50 wt %, or from 30 wt % to 60 wt %, or from 40 wt % to 55 wt %, or from 41 wt % to 52 wt % dimer acid, based on the total weight of the reaction mixture.

In an embodiment, the reaction mixture includes from 10 wt %, or 15 wt % to 25 wt %, or 30 wt %, or 35 wt %, or 40 wt %, or 45 wt %, or 50 wt % dicarboxylic acid, based on the total weight of the reaction mixture. In another embodiment, the reaction mixture includes from 10 wt % to 50 wt %, or from 10 wt % to 40 wt %, or from 10 wt % to 25 wt % dicarboxylic acid, based on the total weight of the reaction mixture.

In an embodiment, the reaction mixture includes from 15 wt %, or 20 wt % to 35 wt %, or 40 wt %, or 45 wt %, or 50 wt % polyol, based on the total weight of the reaction mixture. In another embodiment, the reaction mixture includes from 15 wt % to 50 wt %, or from 15 wt % to 40 wt %, or from 15 wt % to 35 wt % polyol, based on the total weight of the reaction mixture.

In an embodiment, the reaction mixture includes from 15 wt %, or 20 wt % to 35 wt %, or 40 wt %, or 49 wt % diol; and from 0.1 wt %, or 0.5 wt % to 1.0 wt %, or 2.0 wt %, or 5.0 wt % triol, based on the total weight of the reaction mixture.

In an embodiment, the reaction mixture includes, consists essentially of, or consists of, based on the total weight of the reaction mixture: (i) 20 wt % to 60 wt %, or from 20 wt % to 50 wt %, or from 30 wt % to 60 wt %, or from 40 wt % to 55 wt %, or from 41 wt % to 52 wt % dimer acid, based on the total weight of the DAPP Component; (ii) from 10 wt % to 50 wt %, or from 10 wt % to 40 wt %, or from 10 wt % to 25 wt % dicarboxylic acid; (iii) from 15 wt % to 50 wt %, or from 15 wt % to 40 wt %, or from 15 wt % to 35 wt % polyol; and (iv) optionally, from 0 wt %, or 0.001 wt % to 0.1 wt % catalyst, such as tetra-n-butyl titanate.

It is understood that the sum of the components in each of the components, mixtures, compositions, and layers disclosed herein, including the foregoing reaction mixture, yields 100 weight percent (wt %), based on the total weight of the respective component, mixture, composition, or layer.

The reaction mixture is reacted to form a reaction product that includes a dimer acid polyester polyol (a “DAPP”). The DAPP is the polycondensation reaction product of the reaction mixture. In the polycondensation reaction, the carboxyl groups of the dimer acid and the dicarboxylic acid react with the hydroxyl groups of the polyol. In an embodiment, the reaction mixture includes a catalyst, such as tetra-n-butyl titanate. The DAPP reaction product is a hydroxyl-terminated polyester with units derived from the dimer acid.

In an embodiment, the DAPP Component includes from 20 wt %, or 25 wt %, or 30 wt %, or 35 wt %, or 40 wt %, or 41 wt % to 52 wt %, or 55 wt %, or 60 wt % dimer acid, based on the total weight of the DAPP Component. In another embodiment, the DAPP Component includes from 20 wt % to 60 wt %, or from 20 wt % to 50 wt %, or from 30 wt % to 60 wt %, or from 40 wt % to 55 wt %, or from 41 wt % to 52 wt % dimer acid, based on the total weight of the DAPP Component. Not wishing to be bound by any particular theory, it is believed that a DAPP Component containing greater than 60 wt % dimer acid will exhibit (i) incompatibility, (ii) a weight average molecular weight (Mw) and/or (iii) a viscosity that is unsuitable for laminate applications. In contrast, a laminate having an adhesive layer formed from a two-component adhesive composition that is the reaction product of an isocyanate component and a DAPP Component containing less than 20 wt % dimer acid will not exhibit suitable adhesion after the boiling-in-bag test.

In an embodiment, the DAPP has a weight average molecular weight (Mw) from 5000 g/mol, or 10000 g/mol, or 20000 g/mol to 30000 g/mol, or 40000 g/mol, or 50000 g/mol.

In an embodiment, the DAPP has an acid value from 0 mg KOH/g, or 0.01 mg KOH/g to less than 5.0 mg KOH/g.

In an embodiment, the DAPP has a hydroxyl number from 5 mg KOH/g, or 10 mg KOH/g, or 13 mg KOH/g, or 13.5 mg KOH/g to 14 mg KOH/g, or 15 mg KOH/g, or 20 mg KOH/g. In another embodiment, the DAPP has a hydroxyl number from 5 mg KOH/g to 20 mg KOH/g, or from 10 mg KOH/g to 15 mg KOH/g, or from 13.5 mg KOH/g to 15 mg KOH/g.

In an embodiment, the DAPP has one, some, or all of the following properties: (i) from 20 wt % to 60 wt %, or from 20 wt % to 50 wt %, or from 30 wt % to 60 wt %, or from 40 wt % to 55 wt %, or from 41 wt % to 52 wt % dimer acid, based on the total weight of the DAPP Component; and/or (ii) has a weight average molecular weight (Mw) from 5000 g/mol, or 10000 g/mol, or 20000 g/mol to 30000 g/mol, or 40000 g/mol, or 50000 g/mol and/or (iii) has an acid value from 0 mg KOH/g, or 0.01 mg KOH/g to less than 5.0 mg KOH/g; and/or (iv) a hydroxyl number from 5 mg KOH/g to 20 mg KOH/g, or from 10 mg KOH/g to 15 mg KOH/g, or from 13.5 mg KOH/g to 15 mg KOH/g.

In an embodiment, the DAPP has 20 wt % to 60 wt %, or from 20 wt % to 50 wt %, or from 30 wt % to 60 wt %, or from 40 wt % to 55 wt %, or from 41 wt % to 52 wt % dimer acid, based on the total weight of the DAPP Component; and the DAPP has an acid value from 0 mg KOH/g to less than 5.0 mg KOH/g.

The reaction mixture may comprise two or more embodiments disclosed herein.

Optional DAPP Component Additive

In an embodiment, the DAPP Component contains the DAPP and an optional additive.

A nonlimiting example of a suitable optional additive is a polyol. The polyol may be any polyol disclosed herein, with the proviso that the optional polyol is different than the DAPP. The polyol may be compositionally distinct and/or physically distinct from the DAPP.

In an embodiment, the optional additive is a polyol that is a polyester polyol, a polyether polyol, or a combination thereof. Nonlimiting examples of suitable polyether polyols include polypropylene glycol (PPG), polyethylene glycol (PEG), polybutylene glycol, polytetramethylene ether glycol (PTMEG), and combinations thereof.

The DAPP may comprise two or more embodiments disclosed herein.

The DAPP Component may comprise two or more embodiments disclosed herein.

C. Solvent

The two-component solvent-based adhesive composition contains the reaction product of (A) the isocyanate component; (B) the DAPP Component; and (C) a solvent.

A “solvent” is a compound that is a liquid at 25° C., and is capable of providing a continuous medium in which each of the other component in the adhesive composition is dissolved and/or dispersed within.

Nonlimiting examples of suitable solvents includes hydrocarbon solvents, polar solvents, and combinations thereof.

A “hydrocarbon solvent” contains only hydrogen and carbon atoms, including branched or unbranched, saturated or unsaturated, cyclic, polycyclic or acyclic species, and combinations thereof. In an embodiment, the hydrocarbon solvent is selected from aromatic hydrocarbon solvents, aliphatic hydrocarbon solvents, and combinations thereof.

An “aromatic hydrocarbon” is a hydrocarbon that contains one or more benzene rings. Nonlimiting examples of aromatic hydrocarbon solvents include toluene and xylene. In an embodiment, the hydrocarbon solvent is an aromatic hydrocarbon solvent that is toluene.

An “aliphatic hydrocarbon” is a hydrocarbon that is an alkane, an alkene, an alkyne, or a derivative of an alkane, an alkene or an alkyne. Nonlimiting examples of aliphatic hydrocarbon solvents include hexene, cyclohexane and methylcyclohexane (MCH). In an embodiment, the hydrocarbon solvent is an aliphatic hydrocarbon solvent containing methylcyclohexane (MCH).

A “polar solvent” is a substance capable of dissolving another substance (solute) to form a uniformly dispersed mixture (solution) at the molecular or ionic level; the solvent composed of molecules in which positive and negative electrical charges are permanently separated, as opposed to nonpolar molecules in which the charges coincide. Nonlimiting examples of polar solvents include alcohols, ketones and esters. In an embodiment, the polar solvent is a ketone. Nonlimiting examples of suitable ketones include acetone, methyl ethyl ketone and cyclohexanone.

In an embodiment, the polar solvent is an ester. Nonlimiting examples of suitable esters include butyl acetate and ethyl acetate.

In an embodiment, the solvent is selected from ethyl acetate, methyl ethyl ketone, and combinations thereof.

The solvent may comprise two or more embodiments disclosed herein.

D. Two-Component Solvent-Based Adhesive Composition

The two-component solvent-based adhesive composition contains the reaction product of (A) the isocyanate component; (B) the DAPP Component containing the reaction product of a reaction mixture including (i) from 20 wt % to 60 wt % dimer acid, (ii) dicarboxylic acid, and (iii) polyol; and (C) the solvent.

The two-component solvent-based adhesive composition is formed by mixing (A) the isocyanate component, (B) the DAPP Component, and (C) the solvent under conditions suitable to react the —NCO groups of the isocyanate component with the hydroxyl groups of the DAPP Component. In an embodiment, (A) the isocyanate component, (B) the DAPP Component, and (C) the solvent are combined and mixed at a temperature from 15° C. to 45° C. for a period from 10 minutes to 30 minutes. In an embodiment, (A) the isocyanate component, (B) the DAPP Component are completely dissolved, or substantially dissolved, in (C) the solvent.

The (C) solvent may be pre-mixed with the (A) isocyanate component and/or the (B) DAPP Component.

In an embodiment, the (C) solvent is pre-mixed with the (A) isocyanate component. In other words, the isocyanate component is mixed with solvent before it contacts the DAPP Component.

In an embodiment, the (C) solvent is pre-mixed with the (B) DAPP Component. In other words, the DAPP Component is mixed with solvent before it contacts the isocyanate component. In an embodiment, the (C) solvent is pre-mixed with the (B) DAPP Component, and the pre-mix has a solids content from 25 wt %, or 50 wt %, or 70 wt %, or 75 wt % to 80 wt %, or 90 wt %. In another embodiment, the (C) solvent is pre-mixed with the (B) DAPP Component, and the pre-mix has a solids content from 25 wt % to 90 wt %, or from 50 wt % to 90 wt %, or from 50 wt % to 80 wt %, or from 70 wt % to 80 wt %, based on the combined weight of solvent and DAPP Component.

In an embodiment, the two-component solvent-based adhesive composition includes

(B) DAPP Component and (A) isocyanate component at a Polyol:Isocyanate Weight Ratio, based on dry weight, from 100:5, or 100:10, or 100:12 to 100:13, or 100:14, or 100:15, or 100:20, or 100:35. In another embodiment, the two-component solvent-based adhesive composition includes (B) DAPP Component and (A) isocyanate component at a Polyol:Isocyanate Weight Ratio from 100:5 to 100:35, or from 100:10 to 100:20, or from 100:10 to 100:15, or from 100:12 to 100:13.

In an embodiment, the two-component solvent-based adhesive composition contains from 10 wt %, or 20 wt %, or 30 wt %, or 40 wt %, or 50 wt % to 60 wt %, or 70 wt %, or 75 wt % solvent, based on the total weight of the two-component solvent-based adhesive composition.

In an embodiment, the two-component solvent-based adhesive composition contains, consists essentially of, or consists of, the reaction product of

(A) an isocyanate component comprising a multifunctional isocyanate;

(B) a dimer acid polyester polyol component containing, consisting essentially of, or consisting of, the reaction product of a reaction mixture including: (i) from 20 wt % to 60 wt %, or from 20 wt % to 50 wt %, or from 30 wt % to 60 wt %, or from 40 wt % to 55 wt %, or from 41 wt % to 52 wt % dimer acid having one, some, or all of the following properties: (1) an acid value from 150 mg KOH/g to 250 mg KOH/g, or from 180 mg KOH/g to 220 mg KOH/g, or from 190 mg KOH/g to 200 mg KOH/g; and/or (2) the Structure (A); and/or (3) is a C₃₆ dimer acid; (ii) from 10 wt % to 50 wt %, or from 10 wt % to 40 wt %, or from 10 wt % to 25 wt % dicarboxylic acid, selected from phthalic acid, isophthalic acid, terephthalic acid, azelaic acid, sebacic acid, adipic acid, and combinations thereof, and (iii) from 15 wt % to 50 wt %, or from 15 wt % to 40 wt %, or from 15 wt % to 35 wt % polyol containing, consisting essentially of, or consisting of: (1) from 96.0 wt %, or 98.0 wt %, or 98.4 wt % to 98.7 wt %, or 99.0 wt % diol, based on the total weight of polyol in the reaction mixture; (2) from 1.0 wt %, or 1.3 wt % to 1.6 wt %, or 2.0 wt %, or 4.0 wt % triol, based on the total weight of polyol in the reaction mixture;

wherein the DAPP Component has one, some, or all, of the following properties: (i) includes from 20 wt % to 60 wt %, or from 20 wt % to 50 wt %, or from 30 wt % to 60 wt %, or from 40 wt % to 55 wt %, or from 41 wt % to 52 wt % dimer acid, based on the total weight of the DAPP Component; and/or (ii) a weight average molecular weight (Mw) from 5000 g/mol, or 10000 g/mol, or 20000 g/mol to 30000 g/mol, or 40000 g/mol, or 50000 g/mol; and/or (iii) an acid value from 0 mg KOH/g, or 0.01 mg KOH/g to less than 5.0 mg KOH/g;

(C) a solvent; and

(D) optionally, an additive;

wherein the two-component solvent-based adhesive composition has a Polyol:Isocyanate Weight Ratio from 100:5 to 100:35, or from 100:10 to 100:20, or from 100:10 to 100:15, or from 100:12 to 100:13.

The two-component solvent-based adhesive composition may comprise two or more embodiments disclosed herein.

E. Laminate

The present disclosure provides a laminate. The laminate includes a first substrate, a second substrate, and an adhesive layer between the first substrate and the second substrate. The adhesive layer is formed from the two-component solvent-based adhesive composition.

The two-component solvent-based adhesive composition may be any two-component solvent-based adhesive composition disclosed herein.

First Substrate and Second Substrate

The laminate includes a first substrate and a second substrate.

The first substrate and the second substrate may be the same or different. In an embodiment, the first substrate and the second substrate are the same, such that they have the identical compositions and identical structures.

In an embodiment, the first substrate and the second substrate are compositionally distinct and/or structurally distinct from one another.

It is understood that the below description referring to a “substrate” refers to the first substrate and the second substrate, individually and/or collectively.

A nonlimiting example of a suitable substrate is a film. The film may be a monolayer film or a multilayer film. The multilayer film contains two layers, or more than two layers. For example, the multilayer film can have two, three, four, five, six, seven, eight, nine, ten, eleven, or more layers. In an embodiment, the multilayer film contains only two layers, or only three layers.

In an embodiment, the film is a monolayer film with one, and only one, layer.

In an embodiment, the film includes a layer containing a component selected from ethylene-based polymer (PE), propylene-based polymer (PP), polyamide (such as nylon), polyester, ethylene vinyl alcohol (EVOH) copolymer, polyethylene terephthalate (PET), ethylene vinyl acrylate (EVA) copolymer, ethylene methyl acrylate copolymer, ethylene ethyl acrylate copolymer, ethylene butyl acrylate copolymer, ethylene acrylic acid copolymer, ethylene methacrylic acid copolymer, an ionomer of ethylene acrylic acid, an ionomer of methacylic acid, maleic anhydride grafted ethylene-based polymer, a polylactic acid (PLA), a polystyrene, a metal foil, a cellulose, cellophane, nonwoven fabric, and combinations thereof. A nonlimiting example of a suitable metal foil is aluminum foil. Each layer of a multilayer film may for formed from the same component, or from different components.

In an embodiment, the film includes a layer containing metal foil.

In an embodiment, the film is a monolayer film having a single layer that is an ethylene-based polymer layer. In a further embodiment, the film is a monolayer film having a single layer that is a polyethylene layer.

The substrate, and further the film, is a continuous structure with two opposing surfaces.

In an embodiment, the substrate has a thickness from 5 μm, or 10 μm, or 12 μm, or 15 μm, or 20 μm, or 21 μm to 23 μm, or 24 μm, or 25 μm, or 30 μm, or 35 μm, or 40 μm, or 45 μm, or 50 μm, or 100 μm, or 150 μm, or 200 μm, or 250 μm, or 300 μm, or 350 μm, or 400 μm, or 450 μm, or 500 rm.

In an embodiment, the substrate excludes cellulose-based substrates, such as paper and wood.

In an embodiment, the first substrate is a film having a layer that is a metal foil layer; and the second substrate is a monolayer film having a single layer that is a PE layer.

The film may comprise two or more embodiments disclosed herein.

The first substrate may comprise two or more embodiments disclosed herein.

The second substrate may comprise two or more embodiments disclosed herein.

The two-component solvent-based adhesive composition is applied between the first substrate and the second substrate, such as with a Nordmeccanica Labo Combi 400 laminator.

Nonlimiting examples of suitable application methods include brushing, pouring, spraying, coating, rolling, spreading, and injecting.

In an embodiment, the two-component solvent-based adhesive composition is applied between the first substrate and the second substrate at a coat weight, based on the dry weight, from 3.0 grams per square meter (g/m²), or 3.5 g/m², or 4.0 g/m² to 4.5 g/m²; or 5.0 g/m². In another embodiment, the two-component solvent-based adhesive composition is applied between the first substrate and the second substrate at a coat weight from 3.0 g/m² to 5.0 g/m², or from 4.0 g/m² to 4.5 g/m².

In an embodiment, the two-component solvent-based adhesive composition is uniformly applied between on first substrate, the solvent is evaporated to form an adhesive layer, and then the adhesive layer is brought into contact with the second substrate. A “uniform application” is a layer of the composition that is continuous (not intermittent) across a surface of the substrate, and of the same, or substantially the same, thickness across the surface of the substrate. In other words, a composition that is uniformly applied to a substrate directly contacts the substrate surface, and the composition is coextensive with the substrate surface.

The two-component solvent-based adhesive composition and the first substrate are in direct contact with each other. The term “directly contacts,” as used herein, is a layer configuration whereby a substrate is located immediately adjacent to a two-component solvent-based adhesive composition, or an adhesive layer and no intervening layers, or no intervening structures, are present between the substrate and the two-component solvent-based adhesive composition, or the an adhesive layer. The two-component solvent-based adhesive composition directly contacts a surface of the first substrate. The structure containing the first substrate and the two-component solvent-based adhesive composition has the following Structure (B):

First Substrate/Two-Component Solvent-Based Adhesive Composition Structure (B)

In an embodiment, the Structure (B) is dried to form an adhesive layer in direct contact with the first substrate. In an embodiment, the Structure (B) is dried by passing it through an oven at a temperature sufficient to to evaporate all, or substantially all, of the solvent from the two-component solvent-based adhesive composition. Then, the adhesive layer is contacted with the second substrate to form a laminate. The laminate has the following Structure (C):

First Substrate/Adhesive Layer/Second Substrate Structure (C).

In an embodiment, the adhesive layer and the second substrate are in direct contact with each other. The adhesive layer directly contacts a surface of the second substrate.

The adhesive layer of Structure (B) is formed from curing, or drying the two-component solvent-based adhesive composition. The two-component solvent-based adhesive composition is formed from mixing and reacting the (A) isocyanate component and the (B) DAPP Component in the presence of (C) a solvent.

In an embodiment, the two-component solvent-based adhesive composition is cured in the absence, or in the substantial absence, of a photo-initiator.

In an embodiment, the two-component solvent-based adhesive composition is cured in the absence, or in the substantial absence, of water.

The laminate includes the first substrate in direct contact with the adhesive layer, and the second substrate in direct contact with the adhesive layer.

The laminate includes alternating substrate layers and adhesive layers. The laminate includes at least three total layers, total layers including the substrate layers and the adhesive layers. In an embodiment, the laminate includes from three to four, or five, or six, or seven, or eight, or nine, or ten total layers.

In an embodiment, the first substrate is a film having a layer that is a metal foil layer; and the second substrate is a monolayer film having a single layer that is a PE layer, and the laminate has an initial bond strength from 5 N/15 mm, or 9 N/15 mm, or 10 N/15 mm to 11 N/15 mm, or 12 N/15 mm, or 15 N/15 mm. In a further embodiment, the laminate has an initial bond strength from 10 N/15 mm to 15 N/15 mm, or from 10 N/15 mm to 12 N/15 mm. In another embodiment, the laminate has an initial bond strength greater than 5 N/15 mm, or greater than 9 N/15 mm, or greater than 10 N/15 mm.

In an embodiment, the first substrate is a film having a layer that is a metal foil layer; and the second substrate is a monolayer film having a single layer that is a PE layer, and the laminate has a bond strength after the boil-in-bag test from 4.0 N/15 mm, or 5.0 N/15 mm, or 6.0 N/15 mm to 8.0 N/15 mm, or 9.0 N/15 mm, or 10 N/15 mm, or 15 N/15 mm. In a further embodiment, the laminate has a bond strength after the boil-in-bag test from 4.0 N/15 mm to 15 N/15 mm, or from 5.0 N/15 mm to 10 N/15 mm, or from 6.0 N/15 mm to 8.0 N/15 mm. In another embodiment, the laminate has a bond strength after the boil-in-bag test greater than 4 N/15 mm, or greater than 5 N/15 mm, or greater than 6 N/15 mm.

In an embodiment, the first substrate is a film having a layer that is a metal foil layer; and the second substrate is a monolayer film having a single layer that is a PE layer, and the laminate has a bond strength retention after the boil-in-bag test of at least 50%, or at least 55%, or at least 60%, or at least 65%, or at least 68%. In another embodiment, the laminate has a bond strength retention after the boil-in-bag test from 50% to 100%, or from 60% to 100%, or from 65% to 100%.

In an embodiment, the first substrate is a film having a layer that is a metal foil layer; and the second substrate is a monolayer film having a single layer that is a PE layer, and the laminate has a bond strength after chemical aging from 2.0 N/15 mm, or 2.5 N/15 mm, or 3.0 N/15 mm, or 3.5 N/15 mm to 4.0 N/15 mm, or 5.0 N/15 mm, or 7.0 N/15 mm, or 10 N/15 mm. In a further embodiment, the laminate has a bond strength after chemical aging from 2.0 N/15 mm to 10 N/15 mm, or from 3.0 N/15 mm to 10 N/15 mm, or from 3.0 N/15 mm to 5.0 N/15 mm. In another embodiment, the laminate has a bond strength after chemical aging greater than 2 N/15 mm, or greater than 3 N/15 mm, or greater than 3.5 N/15 mm.

In an embodiment the first substrate is a film having a layer that is a metal foil layer; and the second substrate is a monolayer film having a single layer that is a PE layer, and the laminate has a bond strength retention after chemical aging of at least 25%, or at least 30%, or at least 35%. In another embodiment, the laminate has a bond strength retention after chemical aging from 25% to 100%, or from 30% to 100%, or from 35% to 100%.

In an embodiment, the first substrate is a film having a layer that is a metal foil layer; and the second substrate is a monolayer film having a single layer that is a PE layer, and the laminate has an initial heat seal strength from 30 N/15 mm, or 40 N/15 mm, or 45 N/15 mm, or 50 N/15 mm to 60 N/15 mm, or 70 N/15 mm, or 75 N/15 mm, or 100 N/15 mm. Ina further embodiment, the laminate has an initial heat seal strength from 30 N/15 mm to 100 N/15 mm, or from 40 N/15 mm to 75 N/15 mm, or from 45 N/15 mm to 75 N/15 mm. In another embodiment, the laminate has an initial heat seal strength greater than 30 N/15 mm, or greater than 40 N/15 mm, or greater than 50 N/15 mm.

In an embodiment, the first substrate is a film having a layer that is a metal foil layer; and the second substrate is a monolayer film having a single layer that is a PE layer, and the laminate has a heat seal strength after the boil-in-bag test from 35 N/15 mm, or 40 N/15 mm, or 45 N/15 mm, or 50 N/15 mm to 55 N/15 mm, or 60 N/15 mm, or 65 N/15 mm, or 70 N/15 mm, or 75 N/15 mm. In a further embodiment, the laminate has a heat seal strength after the boil-in-bag test from 35 N/15 mm to 75 N/15 mm, or from 40 N/15 mm to 75 N/15 mm, or from 50 N/15 mm to 75 N/15 mm. In another embodiment, the laminate has a heat seal strength after the boil-in-bag test greater than 35 N/15 mm, or greater than 40 N/15 mm, or greater than 50 N/15 mm.

In an embodiment, the first substrate is a film having a layer that is a metal foil layer; and the second substrate is a monolayer film having a single layer that is a PE layer, and the laminate has a heat seal strength retention after the boil-in-bag test of at least 80%, or at least 85%, or at least 90%, or at least 95%, or at least 100%.

In an embodiment, the first substrate is a film having a layer that is a metal foil layer; and the second substrate is a monolayer film having a single layer that is a PE layer, and the laminate has a heat seal strength after chemical aging from 35 N/15 mm, or 40 N/15 mm, or 41 N/15 mm to 45 N/15 mm, or 50 N/15 mm, or 60 N/15 mm, or 70 N/15 mm, or 75 N/15 mm. In a further embodiment, the laminate has a heat seal strength after chemical aging from 35 N/15 mm to 75 N/15 mm, or from 40 N/15 mm to 75 N/15 mm. In another embodiment, the laminate has a heat seal strength after chemical aging greater than 35 N/mm, or greater than 40 N/15 mm.

In an embodiment, the first substrate is a film having a layer that is a metal foil layer; and the second substrate is a monolayer film having a single layer that is a PE layer, and the laminate has a heat seal strength retention after chemical aging of at least 75%, or at least 80%, or at least 82%. In another embodiment, the laminate has a heat seal strength retention after chemical aging from 75% to 100%, or from 80% to 100%, or from 82% to 100%.

In an embodiment, the first substrate is a film having a layer that is a metal foil layer; and the second substrate is a monolayer film having a single layer that is a PE layer, and the laminate does not bubble after the boil-in-bag test.

In an embodiment, the first substrate is a film having a layer that is a metal foil layer; and the second substrate is a monolayer film having a single layer that is a PE layer, and the laminate does not delaminate after chemical aging.

In an embodiment, the first substrate is a film having a layer that is a metal foil layer; and the second substrate is a monolayer film having a single layer that is a PE layer, and the laminate has (A) a bond strength after the boil-in-bag test from 4.0 N/15 mm to 15 N/15 mm, or from 5.0 N/15 mm to 10 N/15 mm, or from 6.0 N/15 mm to 8.0 N/15 mm; and (B) a bond strength after chemical aging from 2.0 N/15 mm to 10 N/15 mm, or from 3.0 N/15 mm to 10 N/15 mm, or from 3.0 N/15 mm to 5.0 N/15 mm.

In an embodiment, the first substrate is a film having a layer that is a metal foil layer; and the second substrate is a monolayer film having a single layer that is a PE layer, and the laminate has (A) a heat seal strength after the boil-in-bag test from 35 N/15 mm to 75 N/15 mm, or from 40 N/15 mm to 75 N/15 mm, or from 50 N/15 mm to 75 N/15 mm; and (B) a heat seal strength after chemical aging from 35 N/mm to 75 N/15 mm, or from 40 N/15 mm to 75 N/15 mm.

In an embodiment, the laminate includes, consists essentially of, or consists of:

a first substrate that is a film having a layer that is a metal foil layer;

a second substrate that is a monolayer film having a single layer that is a PE layer; and

an adhesive layer between the first substrate and the second substrate, the adhesive layer formed from a two-component solvent-based adhesive composition containing, consisting essentially of, or consisting of the reaction product of:

(A) an isocyanate component comprising a multifunctional isocyanate;

(B) a dimer acid polyester polyol component containing, consisting essentially of, or consisting of, the reaction product of a reaction mixture including: (i) from 20 wt % to 60 wt %, or from 20 wt % to 50 wt %, or from 30 wt % to 60 wt %, or from 40 wt % to 55 wt %, or from 41 wt % to 52 wt % dimer acid, the dimer acid having one, some, or all of the following properties: (1) an acid value from 150 mg KOH/g to 250 mg KOH/g, or from 180 mg KOH/g to 220 mg KOH/g, or from 190 mg KOH/g to 200 mg KOH/g; and/or (2) the Structure (A); and/or (3) is a C₃₆ dimer acid; (ii) from 10 wt % to 50 wt %, or from 10 wt % to 40 wt %, or from 10 wt % to 25 wt % dicarboxylic acid, selected from phthalic acid, isophthalic acid, terephthalic acid, azelaic acid, sebacic acid, adipic acid, and combinations thereof, and (iii) from 15 wt % to 50 wt %, or from 15 wt % to 40 wt %, or from 15 wt % to 35 wt % polyol containing, consisting essentially of, or consisting of: (1) from 96.0 wt %, or 98.0 wt %, or 98.4 wt % to 98.7 wt %, or 99.0 wt % diol, based on the total weight of polyol in the reaction mixture; (2) from 1.0 wt %, or 1.3 wt % to 1.6 wt %, or 2.0 wt %, or 4.0 wt % triol, based on the total weight of polyol in the reaction mixture;

wherein the DAPP Component includes from 20 wt % to 60 wt %, or from 20 wt % to 50 wt %, or from 30 wt % to 60 wt %, or from 40 wt % to 55 wt %, or from 41 wt % to 52 wt % units derived from dimer acid, based on the total weight of the DAPP, and the DAPP has one, or both, of the following properties: (i) a weight average molecular weight (Mw) from 5000 g/mol, or 10000 g/mol, or 20000 g/mol to 30000 g/mol, or 40000 g/mol, or 50000 g/mol; and/or (ii) an acid value from 0 mg KOH/g, or 0.01 mg KOH/g to less than 5.0 mg KOH/g;

(C) a solvent; and

(D) optionally, an additive;

wherein the two-component solvent-based adhesive composition has a Polyol:Isocyanate Weight Ratio from 100:10 to 100:15, or from 100:12 to 100:13;

wherein the laminate has one, some, or all of the following properties: (A) an initial bond strength from 10 N/15 mm to 15 N/15 mm, or from 10 N/15 mm to 12 N/15 mm; and/or (B) a bond strength after the boil-in-bag test from 4.0 N/15 mm to 15 N/15 mm, or from 5.0 N/15 mm to 10 N/15 mm, or from 6.0 N/15 mm to 8.0 N/15 mm; and/or (C) a bond strength retention after the boil-in-bag test from 50% to 100%, or from 60% to 100%, or from 65% to 100%; and/or (D) a bond strength after chemical aging from 2.0 N/15 mm to 10 N/15 mm, or from 3.0 N/15 mm to 10 N/15 mm, or from 3.0 N/15 mm to 5.0 N/15 mm; and/or (E) a bond strength retention after chemical aging from 25% to 100%, or from 30% to 100%, or from 35% to 100%; and/or (F) an initial heat seal strength from 30 N/15 mm to 100 N/15 mm, or from 40 N/15 mm to 75 N/15 mm, or from 45 N/15 mm to 75 N/15 mm; and/or (G) a heat seal strength after the boil-in-bag test from 35 N/15 mm to 75 N/15 mm, or from 40 N/15 mm to 75 N/15 mm, or from 50 N/15 mm to 75 N/15 mm; and/or (H) a heat seal strength retention after the boil-in-bag test of at least 80%, or at least 85%, or at least 90%, or at least 95%, or at least 100%; and/or (I) a heat seal strength after chemical aging from 35 N/15 mm to 75 N/15 mm, or from 40 N/15 mm to 75 N/15 mm; and/or (J) a heat seal strength retention after chemical aging from 75% to 100%, or from 80% to 100%, or from 82% to 100%; and/or (K) the laminate does not bubble after the boil-in-bag test; and/or (L) the laminate does not delaminate after chemical aging.

The laminate may comprise two or more embodiments disclosed herein.

F. Method of Forming a Two-Component Solvent-Based Adhesive Composition

The present disclosure also provides a method of forming the two-component solvent-based adhesive composition.

In an embodiment, the method includes (i) providing a DAPP Component containing from 20 wt % to 60 wt % units derived from dimer acid, based on the total weight of the DAPP Component; (ii) providing an isocyanate component, and (iii) reacting the DAPP Component with the isocyanate component to form the two-component solvent-based adhesive composition.

The DAPP Component, the isocyanate component, and the two-component solvent-based adhesive composition may be any respective DAPP Component, isocyanate component, and two-component solvent-based adhesive composition disclosed herein.

In an embodiment, the process includes forming the DAPP Component by (a) providing a reaction mixture containing from 20 wt % to 60 wt % dimer acid, a dicarboxylic acid, and a polyol; and (b) polycondensing the reaction mixture to form a dimer acid polyester polyol component.

The (C) solvent may be pre-mixed with the (A) isocyanate component and/or the (B) DAPP Component.

The method may comprise two or more embodiments disclosed herein.

The present disclosure also provides an article containing the laminate. Nonlimiting examples of suitable articles include packages, bags, and pouches.

In an embodiment, the laminate contacts a comestible. A “comestible” is an edible food item.

By way of example, and not limitation, some embodiments of the present disclosure will now be described in detail in the following Examples.

### EXAMPLES

The materials used in the examples are provided in Table 1 below.

TABLE 1

| Material | Properties | Source |
|---|---|---|
| Coreactant F | solvent-based polyisocyanate composition | The Dow Chemical |
| | 75wt % polyisocyanate¹; 25wt % ethyl acetate¹ | Company |
| ATUREX ™ 1001 | dimer acid (CAS 61788-89-4) having the Structure (A) | Aturex Group |
| | greater than 98 wt % dimer; acid value = 194-200 mg | |
| | KOH/g | |
| phthalic acid | 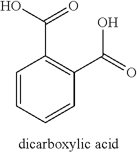 [SMILES: O=C(O)c1ccccc1C(=O)O] | Sinopharm |
| 2-methyl-1,3-propanediol (MPG) | 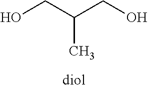 | Sigma |
| trimethylolpropane (TMP) | 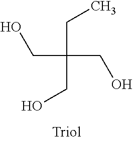 | Sinopharm |
| TYZOR ™ TBT | tetra-n-butyl titanate (catalyst) | Sigma |
| ethyl acetate | solvent | Sinopharm |
| ADCOTE ™ 545S | solvent-based polyester polyol composition | The Dow Chemical |
| | 66.7 wt % polyol²; 33.3 wt % methyl ethyl ketone (solvent)² | Company |
| ADCOTE ™ 563EA | solvent-based polyester polyol composition | The Dow Chemical |
| | 80 wt % polyol²; 20 wt % ethyl acetate (solvent)² | Company |

¹Based on the total weight of the solvent-based polyisocyanate composition.
²Based on the total weight of the solvent-based polyol composition.

A. Preparation of the Dimer Acid Polyester Polyol Component

Dimer Acid Polyester Polyol (DAPP) Component Examples 1-2 and Comparative Sample 3 each is prepared by placing the components of Table 2 in a Kettle equipped with an agitator and a glass condenser, and heating the Kettle to 100° C. until the reaction mixture turns to a liquid. The amounts provided in Table 2 are in grams (g). Once the reaction mixture is in a liquid form, the agitator is turned on and the reaction mixture is mixed while monitoring the temperature inside the Kettle and the temperature of the glass condenser, to ensure that the top temperature of the glass condenser is between 100° C. and 103° C. Once the reaction mixture temperature increases to 220° C. and the top temperature of the glass condenser decreases to less than 100° C., a vacuum is slowly started such that the vacuum reaches a pressure of 25-30 mm Hg within 30 minutes of the vacuum being started. A vacuum pressure of 25-30 mm Hg is maintained and the acid value of the reaction mixture is measured every 25-30 minutes. TYZOR™ TBT (catalyst) is incrementally added to the reaction mixture until the acid value of the reaction mixture is equal to less than 25 mg KOH/g. Then, vacuum pressure is reduced to less than 10 mm Hg, and an additional TYZOR™ TBT (catalyst) is incrementally added over the period of at least 1 hour, until the acid value of the reaction mixture is equal to less than 5 mg KOH/g and the hydroxyl value reaches the target hydroxyl value. Then, the reaction product (a dimer acid polyester polyol) is cooled to 60° C., and ethyl acetate (solvent) is added to the reaction product to achieve a solids content of 75 wt %.

TABLE 2
Dimer Acid Polyester Polyol Component
Examples and Comparative Sample

| | | |
|---|---|---|
| DAPP | DAPP | DAPP |
| Component | Component | Comparative |
| Example B1 | Example B2 | Example B3 |

Reaction Mixture

| | | | | | | |
|---|---|---|---|---|---|---|
| ATUREX ™ 1001 (dimer | 20.00 | g | 25.00 | g | 10.00 | g |
| acid) | | | | | | |
| phthalic acid (dicarboxylic | 20.00 | g | 15.00 | g | 30.00 | g |
| acid) | | | | | | |
| MPG (diol) | 26.10 | g | 22.78 | g | 32.70 | g |
| TMP (triol) | 0.365 | g | 0.350 | g | 0.400 | g |
| TYZOR ™ TBT (catalyst) | 0.008 | g | 0.008 | g | 0.008 | g |
| wt % Units Derived from | 41 | wt % | 52 | wt % | 19 | wt % |
| Dimer Acid in Reaction | | | | | | |
| Product | | | | | | |

Dimer Acid Polyester Polyol Component

| | | | | | | |
|---|---|---|---|---|---|---|
| wt % dimer acid polyester | 75 | wt % | 75 | wt % | 75 | wt % |
| polyol | | | | | | |
| wt % ethyl acetate | 25 | wt % | 25 | wt % | 25 | wt % |
| (solvent) | | | | | | |

| | | | |
|---|---|---|---|
| hydroxyl value | 13.7 | 13.6 | 13.3 |
| (mg KOH/g) | | | |

B. Formation of Two-Component Solvent-Based Adhesive Compositions

Two-component solvent-based adhesive compositions are prepared by mixing (A) Coreactant F (a solvent-based polyisocyanate composition) with (B) one of the DAPP Component Examples B1-B2, the DAPP Component Comparative Sample B3, ADCOTE™ 545 S (a polyester polyol component formed without dimer acid) and ADCOTE™ 563 EA (a polyester polyol component formed without dimer acid), in a kettle at room temperature (23° C.) until a homogeneous mixture is achieved, forming a two-component solvent-based adhesive composition. The components of each example and comparative example adhesive composition are provided in Table 3.

C. Formation of a Laminate

A polyethylene (PE) film that is a monolayer film having a thickness of 60 μm is provided.

A metal foil film is provided. The metal foil film is a monolayer film having a thickness of 20 μm. The metal foil film is pre-laminated with a PET film using ADCOTE™ 545 S: Coreactant F (at a weight ratio of 100:11) (a solvent-based, 2-component polyurethane adhesive, commercially available from The Dow Chemical Company) to form a Metal Foil Pre-Laminate having the following Structure (I):PET Film/ADCOTE™ 545 S:Coreactant F Adhesive Layer/Metal Foil Film Structure (I).

The example and comparative example adhesive compositions are loaded into a Nordmeccanica SDC Labo Combi 400 laminator. The laminator nip temperature is maintained at 40° C., the oven temperature is set at 60° C./70° C./80° C. for each zone, and the laminator is operated at a speed of 100 meters per minute (m/min). The adhesive composition is applied to the Metal Foil Pre-Laminate at a coat weight of 4.0-4.5 grams per square meter (g/m²), based on the dry weight of the adhesive composition, to form the following Structure (II):

Metal Foil Pre-Laminate/Adhesive Composition Structure (II).

In Structure (II), the adhesive composition directly contacts the surface of the metal foil film layer of the Metal Foil Pre-Laminate (having the Structure (I)).

Then, the Structure (II) is cured in an oven at a temperature of 50° C. for a period of two days to evaporate all, or substantially all, of the solvent and form an adhesive layer. The PE film is brought into contact with the adhesive layer to form a laminate having the Structure (III):

Metal Foil Pre-Laminate/Adhesive Layer/PE Film Structure (III)

The properties of each laminate example and comparative sample are provided in Table 3.

D. Results

Comparative Sample 4 and Comparative Sample 5 each includes an adhesive layer formed from (A) an isocyanate component (Coreactant F) and (B) a polyester polyol component that is not formed with dimer acid (ADCOTE™ 545 S and ADCOTE™ 563 EA, respectively). The laminate structure of Comparative Sample 4 and Comparative Sample 5 each exhibits (i) bubbling after the boil-in-bag test; (ii) delamination after chemical aging; (iii) a bond strength after the boil-in-bag test of less than 4.0 N/15 mm (3.1 N/15 mm and 1.24 N/15 mm, respectively); (iv) a bond strength after chemical aging of less than 2.0 N/15 mm (0.68 N/15 mm and 0.42 N/15 mm, respectively); (v) a heat seal strength after the boil-in-bag test of less than 35 N/15 mm (30.2 N/15 mm and 21.2 N/15 mm, respectively); and (vi) a heat seal strength after chemical aging of less than 35 N/mm (32.34 N/15 mm and 27.2 N/15 mm, respectively). Thus, Comparative Sample 4 and Comparative Sample 5 each exhibits insufficient bond strength and heat seal strength after the boil-in-bag test, and after chemical aging.

TABLE 3

| | | | | |
|---|---|---|---|---|
| | | Comparative | Comparative | Comparative |
| Example 1 | Example 2 | Sample 3 | Sample 4 | Sample 5 |

Adhesive Composition*

| | | | | | |
|---|---|---|---|---|---|
| Coreactant F (solvent-based | 11.1 wt % | 11.1 wt % | 11.1 wt % | 9.9 wt % | 12.3 wt % |
| polyisocyanate composition) | | | | | |
| DAPP Component Example B1 | 88.9 wt % | — | — | — | — |
| DAPP Component Example B2 | — | 88.9 wt % | — | — | — |
| DAPP Component Comparative | — | — | 88.9 wt % | — | — |
| Example B3 | | | | | |
| ADCOTE ™ 545S (solvent- | — | — | — | 90.1 wt % | — |
| based polyester polyol component) | | | | | |
| ADCOTE ™ 563EA (solvent- | — | — | — | — | 87.7 wt % |
| based polyester polyol component) | | | | | |

Adhesive Composition Properties

| | | | | | |
|---|---|---|---|---|---|
| Polyol:Isocyanate Weight Ratio | 100:12.5 | 100:12.5 | 100:12.5 | 100:11 | 100:14 |
| Polyol Component Dimer Acid | 41 wt % | 52 wt % | 19 wt % | 0 wt % | 0 wt % |
| Content (wt %) | | | | | |
| Adhesive Composition wt % Units | 36 wt % | 46 wt % | 17 wt % | 0 wt % | 0 wt % |
| Derived from Dimer Acid | | | | | |

Laminate Properties

| | | | | | |
|---|---|---|---|---|---|
| Initial Bond Strength (N/15 mm) | 10.74 | 10.14 | 8.79 | 9.62 | 3.6 |
| Bond Strength after Boil-in-Bag | 7.88 | 6.98 | 3.9 | 3.1 | 1.24 |
| (N/15 mm) | | | | | |
| Bond Strength Retention after | 73.4 | 68.8 | 44.4 | 32.2 | 34.4 |
| Boil-in-Bag (%) | | | | | |
| Bond Strength after Chemical | 3.76 | 3.98 | 1.06 | 0.68 | 0.42 |
| Aging (N/15 mm) | | | | | |
| Bond Strength Retention after | 35.0 | 39.3 | 12.1 | 7.1 | 11.7 |
| Chemical Aging (%) | | | | | |
| Initial Heat Seal Strength | 49.8 | 50.1 | 53.2 | 51.3 | 45.2 |
| (N/15 mm) | | | | | |
| Heat Seal Strength after | 50.12 | 51.25 | 38.2 | 30.2 | 21.2 |
| Boil-in-Bag (N/15 mm) | | | | | |
| Heat Seal Strength Retention | 100.6 | 102.3 | 71.8 | 58.9 | 46.9 |
| after Boil-in-Bag (%) | | | | | |
| Heat Seal Strength after | 42.44 | 41.2 | 38.56 | 32.34 | 28.2 |
| Chemical Aging (N/15 mm) | | | | | |
| Heat Seal Strength Retention | 85.2 | 82.2 | 72.5 | 63.0 | 62.4 |
| after Chemical Aging (%) | | | | | |
| Appearance after Boil-in-Bag | Good | Good | Bubble | Bubble | Bubble |
| Appearance after Chemical | Good | Good | Delamination | Delamination | Delamination |
| Aging | | | | | |

*wt % of the respective components is based on the total weight of the adhesive composition (including the isocyanate component, the polyol component, and the solvent)

Comparative Sample 3 includes an adhesive layer formed from (A) an isocyanate component (Coreactant F) and (B) a dimer acid polyester polyol component (DAPP Component Comparative Example B3) prepared with a reaction mixture containing less than 20 wt % dimer acid (19 wt %). The laminate structure of Comparative Sample 3 exhibits bubbling after the boil-in-bag test, and exhibits delamination after chemical aging. Moreover, the laminate structure of Comparative Sample 3 exhibits (i) a bond strength after the boil-in-bag test of less than 4.0 N/15 mm (3.9 N/15 mm); and (ii) a bond strength after chemical aging of less than 2.0 N/15 mm (1.06 N/15 mm). Thus, Comparative Sample 4 and Comparative Sample 5 each exhibits insufficient bond strength after the boil-in-bag test, and after chemical aging.

Example 1 and Example 2 each includes an adhesive layer formed from (A) an isocyanate component (Coreactant F) and (B) a dimer acid polyester polyol component (DAPP Component Examples B1 and B2, respectively) prepared with a reaction mixture containing 20-60 wt % dimer acid (36 wt % and 46 wt %, respectively). The laminate structure of Example 1 and Example 2 each exhibits a good appearance (i.e., no bubbling) after the boil-in-bag test, and each exhibits a good appearance (i.e., no delamination) after chemical aging. Moreover, the laminate structure of Example 1 and Example 2 each exhibits (i) a bond strength after the boil-in-bag test of at least 4.0 N/15 mm (7.88 N/15 mm and 6.98 N/15 mm, respectively); (ii) a bond strength after chemical aging of at least 2.0 N/15 mm (3.76 N/15 mm and 3.98 N/15 mm, respectively); (iii) a heat seal strength after the boil-in-bag test of at least 35 N/15 mm (50.12 N/15 mm and 51.25 N/15 mm, respectively); and (iv) a heat seal strength after chemical aging of at least 35 N/mm (42.44 N/15 mm and 41.2 N/15 mm, respectively). Thus, Example 1 and Example 2 each exhibits sufficient bond strength and heat seal strength after the boil-in-bag test, and after chemical aging.

It is specifically intended that the present disclosure not be limited to the embodiments and illustrations contained herein, but include modified forms of those embodiments including portions of the embodiments and combinations of elements of different embodiments as come within the scope of the following claims.

1. A two-component solvent-based adhesive composition comprising the reaction product of:
(A) an isocyanate component;
(B) a dimer acid polyester polyol component comprising the reaction product of a reaction mixture comprising
(i) from 20 wt % to 60 wt % dimer acid, based on the total weight of the dimer acid polyester polyol component;
(ii) a dicarboxylic acid;
(iii) a polyol; and
(C) a solvent.

2. The two-component solvent-based adhesive composition of claim 1,
wherein the dicarboxylic acid is selected from the group consisting of phthalic acid, isophthalic acid, terephthalic acid, azelaic acid, sebacic acid, adipic acid, and combinations thereof.

3. The two-component solvent-based adhesive composition of claim 1, wherein the polyol is selected from the group consisting of 2-methyl-1, 3-propanediol, trimethylolpropane, 1, 4-butanediol, 1, 6-hexanediol, and neopentyl glycol (NPG), and combinations thereof.

4. The two-component solvent-based adhesive composition of claim 1, wherein the isocyanate is a multifunctional isocyanate.

5. The two-component solvent-based adhesive composition of claim 1, wherein the isocyanate component has an average NCO functionality from 2.2 to 5.0.

6. The two-component solvent-based adhesive composition of claim 1, wherein the two-component solvent-based adhesive composition has a Polyol:Isocyanate Weight Ratio from 100:5 to 100:35.

7. A laminate comprising
a first substrate;
a second substrate; and
an adhesive layer between the first substrate and the second substrate, the adhesive layer formed from the two-component solvent-based adhesive composition of claim 1.

8. The laminate of claim 7, wherein the first substrate is a metal foil film and the second substrate is a polyethylene film; and the laminate has
a bond strength after the boil-in-bag test from 4.0 N/15 mm to 15 N/15 mm;
a bond strength after chemical aging from 2.0 N/15 mm to 10 N/15 mm.

9. The laminate of claim 8, wherein the laminate has
a heat seal strength after the boil-in-bag test from 35 N/15 mm to 75 N/15 mm; and
a heat seal strength after chemical aging from 35 N/mm to 75 N/15 mm.

10. A method of forming a two-component solvent-based adhesive composition comprising:
(i) providing a dimer acid polyester polyol component comprising from 20 wt % to 60 wt % units derived from dimer acid;
(ii) providing an isocyanate component; and
(iii) reacting the dimer acid polyester polyol component with the isocyanate component to form the two-component solvent-based adhesive composition.
